(19) United States
(12) Patent Application Publication
(10) Pub. No.: US 2025/0200179 A1
(43) Pub. Date: Jun. 19, 2025

(54) OPEN SOURCE SOFTWARE BEHAVIORAL VISIBILITY AND THREAT INTELLIGENCE

(71) Applicant: Louisiana Tech Research Corporation; of Louisiana Tech University Foundation, Inc., Ruston, LA (US)

(72) Inventor: Ronald A. Lewis, Ruston, LA (US)

(73) Assignee: Louisiana Tech Research Corporation; of Louisiana Tech University Foundation, Inc., Ruston, LA (US)

(21) Appl. No.: 18/598,199

(22) Filed: Mar. 7, 2024

Related U.S. Application Data
(60) Provisional application No. 63/451,364, filed on Mar. 10, 2023.

(51) Int. Cl. G06F 21/56; G06N 3/09

(52) U.S. Cl. CPC G06F 21/563; G06N 3/09; G06F 2221/033

(57) ABSTRACT

The present disclosure relates to detecting threats relating to open source software components. In accordance with one aspect, a method includes accessing data regarding execution of at least one open source software (OSS) component of an application, processing the data by a trained machine learning (ML) model where the trained ML model provides an indication of whether the at least one OSS component exhibits normal behavior or exhibits potential threat behavior, and communicating the indication.

### CROSS REFERENCE TO RELATED APPLICATION

The present application claims the benefit of and priority to U.S. Provisional Application No. 63/451,364, filed on Mar. 10, 2023, which is hereby incorporated by reference herein in its entirety.

### TECHNICAL FIELD

The present disclosure relates to open source software, and more particularly, to detecting threats relating to open source software components.

### BACKGROUND

Estimates show that open source software (OSS) components may make up over 80% of all modern applications, making OSS components possibly the ultimate Trojan horse for cyber-attackers. Studies estimate that more than 50% of all open source libraries have critical vulnerabilities listed in open databases such as VulnDB, and there has been an increase in the cyber-weaponization of open source libraries by nation states, such as Russia and China.

### SUMMARY

The present disclosure relates to detecting threats relating to open source software components.

In accordance with aspects of the present disclosure, a method includes: accessing data regarding execution of at least one open source software (OSS) component of an application; processing the data by a trained machine learning (ML) model, the trained ML model providing an indication of whether the at least one OSS component exhibits normal behavior or exhibits potential threat behavior; and communicating the indication.

In various embodiments of the method, the at least one OSS component is instrumented by an instrumentation tool, and the method further includes generating, by the instrumentation tool, the data regarding execution of the at least one OSS component.

In various embodiments of the method, the data regarding execution of the at least one OSS component includes at least one of: which routines are called, memory settings, execution order, or exceptions raised.

In various embodiments of the method, processing the data by the trained ML model includes inputting, to the trained ML, at least one of: which routines are called, memory settings, execution order, or exceptions raised.

In various embodiments of the method, the trained ML model includes a neural network trained by supervised learning.

In various embodiments of the method, the method further includes performing continual learning for the trained ML model using new input training data.

In accordance with aspects of the present disclosure, a system includes at least one processor, and one or more memory storing instructions which, when executed by the at least one processor, cause the system at least to: access data regarding execution of at least one open source software (OSS) component of an application; process the data by a trained machine learning (ML) model, the trained ML model providing an indication of whether the at least one OSS component exhibits normal behavior or exhibits potential threat behavior; and communicate the indication.

In various embodiments of the system, the at least one OSS component is instrumented by an instrumentation tool, and the instructions, when executed by the at least one processor, further cause the system at least to: generate, by the instrumentation tool, the data regarding execution of the at least one OSS component.

In various embodiments of the system, the data regarding execution of the at least one OSS component includes at least one of: which routines are called, memory settings, execution order, or exceptions raised.

In various embodiments of the system, processing the data by the trained ML model includes inputting, to the trained ML, at least one of: which routines are called, memory settings, execution order, or exceptions raised.

In various embodiments of the system, the trained ML model includes a neural network trained by supervised learning.

In various embodiments of the system, the instructions, when executed by the at least one processor, further cause the system at least to: perform continual learning for the trained ML model using new input training data.

In accordance with aspects of the present disclosure, a processor-readable medium stores instructions which, when executed by at least one processor of a system, cause the system at least to perform: accessing data regarding execution of at least one open source software (OSS) component of an application; processing the data by a trained machine learning (ML) model, the trained ML model providing an indication of whether the at least one OSS component exhibits normal behavior or exhibits potential threat behavior; and communicating the indication.

In various embodiments of the processor-readable medium, the at least one OSS component is instrumented by an instrumentation tool, and the instructions, when executed by the at least one processor of the system, further cause the system to perform: generating, by the instrumentation tool, the data regarding execution of the at least one OSS component.

In various embodiments of the processor-readable medium, the data regarding execution of the at least one OSS component includes at least one of: which routines are called, memory settings, execution order, or exceptions raised.

In various embodiments of the processor-readable medium, processing the data by the trained ML model includes inputting, to the trained ML, at least one of: which routines are called, memory settings, execution order, or exceptions raised.

In various embodiments of the processor-readable medium, the trained ML model includes a neural network trained by supervised learning.

In various embodiments of the processor-readable medium, the instructions, when executed by the at least one processor of the system, further cause the system to perform: performing continual learning for the trained ML model using new input training data.

The details of one or more embodiments of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

A detailed description of embodiments of the disclosure will be made with reference to the accompanying drawings, wherein like numerals designate corresponding parts in the figures:

FIG. 1 is a diagram of an example of a networked environment, in accordance with aspects of the present disclosure;

FIG. 2 is a diagram of an example of components in a system, device, or server, in accordance with aspects of the present disclosure;

FIG. 3 is a diagram of an example of a machine learning system, in accordance with aspects of the present disclosure;

FIG. 4 is a diagram of an example of operations and components for implementing aspects of the present disclosure; and

FIG. 5 is a flow diagram of an example of operations for detecting potential threat behavior by an OSS component.

### DETAILED DESCRIPTION

The present disclosure relates to detecting threats relating to open source software.

Open source software (“OSS”) components function as a black box, and cyber security teams often have zero visibility into what the OSS components are doing. This makes them a prime target for cyber-weaponization because these OSS components may present a blind spot in the cyber security architecture. At the same time, OSS use is extremely prevalent, which makes cyber-weaponization of OSS components a very concerning problem.

An approach for threat management of OSS components may be to use a threat intelligence source coupled with a vulnerability database, such as VulnDB, to identify threats from OSS components. However, this approach may not be helpful against cyber-weaponization of OSS components. For example, cyber-attackers (e.g., sponsored by nation states) may implement malicious, covert logic channels into common open source libraries that are triggered via exceptions. Such behavior is covert, and since traditional OSS components, from an architectural design perspective, do not perform any type of behavioral reporting, these components may perform covert actions that may go undetected for numerous years. Historically, cyber-attackers were individuals who found and exploited unintentionally introduced weaknesses in existing code. More recently, nation states, such as North Korea, China, and Russia, have joined the trend of introducing flawed logic covertly and intentionally introducing vulnerabilities. Cyber-attackers may weaponize OSS components by, for example, contributing code to common open source libraries (e.g., Linux kernel) with flawed exception handlers that allow them to impact programmatic behaviors. Traditional security methods have no way to identify these behavioral changes.

Compounding the problem is a scenario where seemingly unrelated routines are used in dependent libraries to set conditions in memory that trigger the covert behavior channel. This scenario may render current vulnerability assessment techniques useless for detecting the covert behavior. For example, software composition analysis (e.g., a process that identifies OSS in a codebase) will tell a security analyst the components and libraries included in a build, but it does not identify which routines may be malicious routines. Moreover, correlation of the code elements to a vulnerability database will only provide an understanding of known vulnerabilities (those that have been detected) but cannot provide information about unknown or undetected vulnerabilities. As another example, static analysis (e.g., code scanning) may not identify malicious code because the code scanners cannot do a full trace across code in external libraries, so static analysis may not identify the covert behaviors. Dynamic analysis, on the other hand, has no visibility into OSS component behavior without inaugurating the covert logic, which has low likelihood of occurrence because of the numerous conditions that must be set to inaugurate/initiate these behaviors. Therefore, many security defense analyses may be blind to covert behaviors of OSS components.

Industry and government, among others, have adopted agile software development methodologies to field functionality at higher velocity and, in doing so, have created a dependency on OSS components. Estimates show that OSS components may make up over 80% of all modern applications, making OSS components possibly the ultimate Trojan horse for cyber-attackers. Studies estimate that more than 50% of all open source libraries have critical vulnerabilities listed in open databases such as VulnDB, and there has been an increase in the cyber-weaponization of open source libraries by nation states, such as Russia and China.

Prioritizing development speed, software built using build automation tools may pull OSS components from public repositories. Such build automation allows cyber-attackers (e.g., state-sponsored bad actors) to commit code, such as flawed exception handlers, to public repositories such as DPDK to change behavior at runtime. Most of these behaviors are covert and will often return limited exception data that rarely gets written to application logs. This is one of the reasons why finding and remediating flaws in OSS components takes so long.

Dependence on OSS components to increase agility and developmental velocity should be balanced against the risks of cyber-weaponization of OSS components. The typical deployment of OSS components does not provide visibility into unexpected behaviors, as most such behaviors are hidden from the calling routines. Maintaining a cyber advantage depends on having insight into adversarial behaviors.

The following describes a solution that provides real-time threat intelligence to identify potential covert actions of cyber-attackers attempting to exploit open source flaws. In aspects, the disclosed technology provides an ability to identify the types, frequency, and methodologies that cyber-attackers use in OSS components to gain a “backdoor” to commercial and/or government enterprises.

In accordance with aspects of the present disclosure, a solution for detecting threats from OSS components includes four primary components and a reporting engine. The primary components include: (1) a repository of instrumented OSS components with instrumentation (e.g., using Rollbar and/or Sentry, etc.) that reports on which routines are being called, the memory settings, execution order, and exceptions being raised, among other data; (2) a web-backend that collects data from instrumentation (e.g., using Splunk) and stores it in a cloud based storage; (3) a statistical and/or machine learning model (e.g., neural network) that identifies potential threat behaviors based on the collected data; and (4) an alerting engine that functions as a threat intelligence source. The repository of instrumented OSS components can be used by build engines to incorporate the instrumented OSS components into application releases. The machine learning model and alerting engine can operate in real-time or near-real-time to identify potential threat behavior and provide alerts. The terms “real-time” and “near-real-time” are context and application dependent, and persons skilled in the art will understand what constitute real-time and near-real-time for any particular context and/or application.

One challenge is that the instrumentation creates a lot of data. In embodiments, to address this challenge, the data generated by the instrumentation is consumed by a machine learning model (e.g., neural network) which is frequently or “constantly” being trained on “normal behavior.” In embodiments, normal behavioral data, once ingested, may be partially archived in a way that maintains a behavioral data warehouse while practically managing the amount of data in the warehouse. Anomalous behavioral data is immediately converted to threat intelligence.

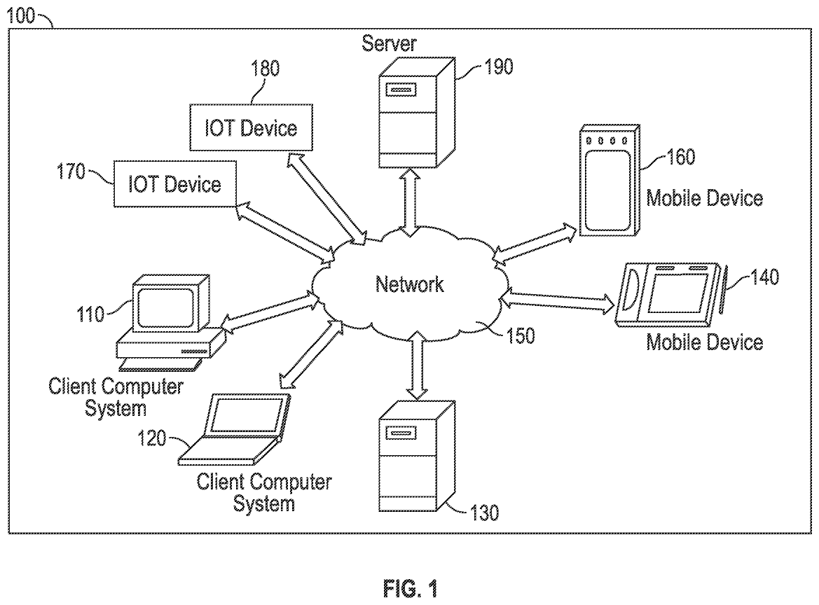

Referring to FIG. 1, there is shown an illustration of an exemplary networked environment 100 in accordance with aspects of the present disclosure. The system 100 includes one or more client computer systems 110, 120, a cloud system 130, a network 150, one or more mobile devices 140, 160, one or more Internet of Things (IoT) devices 170, 180, and a server 190. The client computer systems 110, 120 communicate with the server 190 across the network 150. It is contemplated that multiple servers 190 may be used in a distributed architecture and/or in a cloud.

The server 190 provides a repository of instrumented OSS components that may be accessed by developers and/or by build automation software at the client computer systems 110, 120 to build applications. The term “application” may include a computer program designed to perform particular functions, tasks, or activities. An application may be software or firmware and may be deployed on any platform, such as on the client computer systems 110, 120, on mobile devices 140, 160, and/or on IoT devices 170, 180, among others, such as, but not limited to, consumer electronics, networking devices, enterprise systems, etc. An application may refer to, for example, software running locally or remotely, as a standalone program or in a web browser, or other software which would be understood by one skilled in the art to be an application. In embodiments, an application may run on a server and/or on a user device. Two client computer systems 110, 120 are illustrated as examples, but more than two client computer systems may exist in the networked environment 100.

The network 150 may be wired or wireless, and can utilize technologies such as Wi-Fi, Ethernet, Internet Protocol, 4G, and/or 5G, or other communication technologies. The network 150 may include, for example, but is not limited to, a cellular network, residential broadband, satellite communications, private network, the Internet, local area network, wide area network, storage area network, campus area network, personal area network, or metropolitan area network.

The applications using instrumented OSS components provide reports on, e.g., which routines are being called, the memory settings, execution order, and/or exceptions being raised, among other possibilities. The reports may be communicated to the cloud system 130 using, e.g., a web-backend that collects the data from instrumentation (e.g., using Splunk). As will be described in more detail below, the cloud system 130 may implement a statistical and machine learning models (e.g., neural network) that processes the collected data to identify potential threat behaviors. The term “machine learning model” may include, but is not limited to, neural networks, recurrent neural networks (RNN), generative adversarial networks (GAN), decision trees, Bayesian Regression, Naive Bayes, nearest neighbors, least squares, means, and support vector machine, among other data science and machine learning techniques which persons skilled in the art will recognize.

The illustrated networked environment is merely an example. In embodiments, other systems, servers, and/or devices not illustrated in FIG. 1 may be included. In embodiments, one or more of the illustrated components may be omitted. Such and other embodiments are contemplated to be within the scope of the present disclosure.

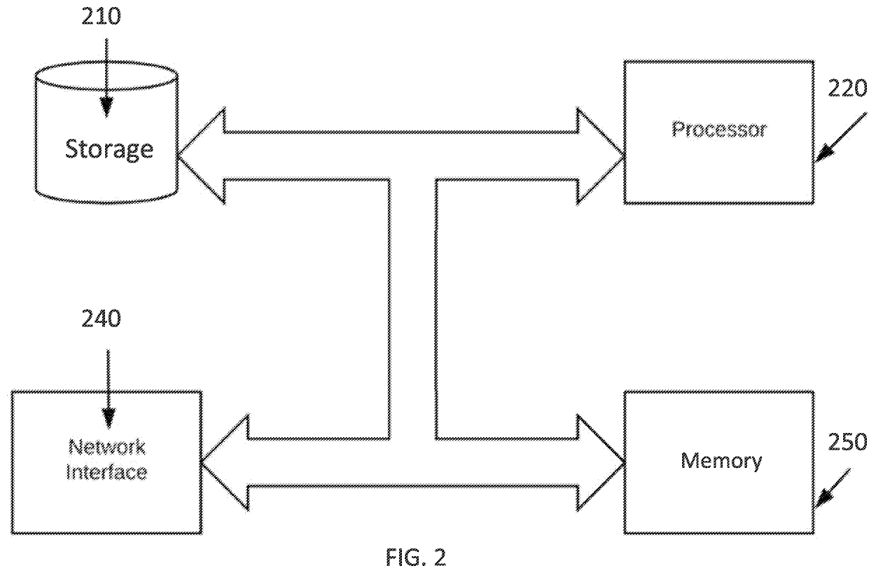

Referring now to FIG. 2, there is shown a block diagram of example components of any of the systems, devices, and/or servers of FIG. 1. The components include an electronic storage 210, a processor 220, a memory 250, and a network interface 240, among other components that persons skilled in the art will recognize. The various components may be communicatively coupled with each other. The processor 220 may be and may include any type of processor, such as a single-core central processing unit (CPU), a multi-core CPU, a microprocessor, a microcontroller, a digital signal processor (DSP), a System-on-Chip (SoC), an application specific integrated circuit (ASIC), or any other type of processor. The memory 250 may be a volatile type of memory, e.g., RAM, or a non-volatile type of memory, e.g., NAND flash memory. The memory 250 includes processor-readable instructions that are executable by the processor 220 to cause the systems, devices, and/or servers to perform various operations, including those mentioned herein.

The electronic storage 210 may be and include any type of electronic storage used for storing data, such as hard disk drive, solid state drive, and/or optical disc, among other types of electronic storage. The electronic storage 210 may be a processor-readable medium. The electronic storage 210 stores processor-readable instructions for causing the systems, devices, and/or servers to perform operations and store data associated with such operations. The network interface 240 may implement wireless networking technologies and/or wired networking technologies.

The components shown in FIG. 2 are merely examples, and persons skilled in the art will understand that systems, devices, and/or servers include other components not illustrated and may include multiples of any of the illustrated components. Such and other embodiments are contemplated to be within the scope of the present disclosure.

In accordance with aspects of the present disclosure, the components of FIG. 2 may implement one or more machine learning (ML) models (e.g., neural network) and/or implements training of one or more ML models configured to process data from instruments OSS components and detect potential threat behavior. In embodiments, the ML model(s) may be or include classical ML models (e.g., ML models that involve feature engineering). In embodiments, the ML model(s) may be or include deep neural networks, such as recurrent neural networks, among others. The training of the ML model(s) includes supervised training, which persons skilled in the art will understand.

In accordance with aspects of the present disclosure, the training of the ML model(s) uses what is referred to herein as “continual training,” which means and includes training/retraining that is performed over time for the same ML model architecture and the same input feature space, using new data as it becomes available, without training the ML model from scratch. Using continual learning, an ML model is usable after each training iteration.

The following description will illustrate and describe a deep learning neural network as an example of a machine learning model usable in accordance with aspects of the present disclosure. However, it is intended for the present disclosure to apply to other types of machine learning models as well. Accordingly, any description herein referring to a neural network shall be treated as though such description refers to other types of ML models, as well.

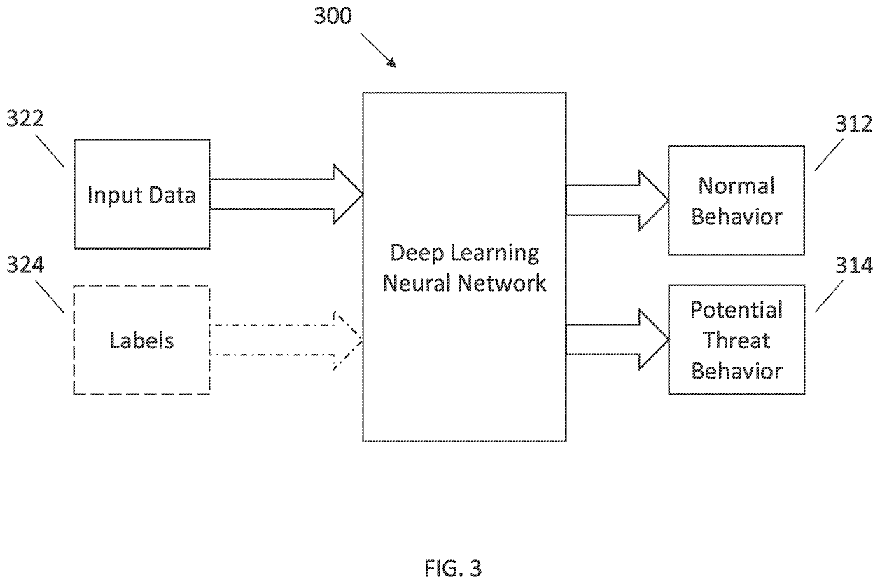

Referring now to FIG. 3, there is shown a block diagram of an exemplary deep learning neural network 300 for processing input data to determine potential threat behavior of OSS components. The deep learning neural network 300 can be implemented and executed by the cloud system 130 of FIG. 1. Generally, and as persons skilled in the art will understand, a deep learning neural network 300 includes an input layer, a plurality of hidden layers, and an output layer. The input layer, the hidden layers, and the output layer all include neurons/nodes. The neurons between the various layers are interconnected via weights. Each neuron in the deep learning neural network 300 computes an output value by applying a specific function to the input values coming from the nodes in the previous layer. The function that is applied to the input values is determined by a vector of weights and a bias. Learning, in the deep learning neural network, progresses by making iterative adjustments to these biases and weights.

In the illustrated embodiment, the deep learning neural network 300 may classify the input data 322, reported by instrumented OSS components, as normal behavior 312 or potential threat behavior 314. The deep learning neural network 300 may be executed on the cloud system 130 of FIG. 1. Persons skilled in the art will understand the deep learning neural network 300 and how to implement it.

The deep learning neural network 300 may be trained based on labels 324 for training input data. For example, training input data may be labeled as reflecting normal behavior 312 or as reflecting potential threat behavior 314. In various embodiments, the deep learning neural network 300 may be trained by supervised learning, continual learning, and/or reinforcement learning, among others. The labels 324 are shown by dashed lines in FIG. 3 to indicate they are used for training and are not used when applying a trained model. Persons skilled in the art will understand training of a deep learning neural network 300 and how to implement it.

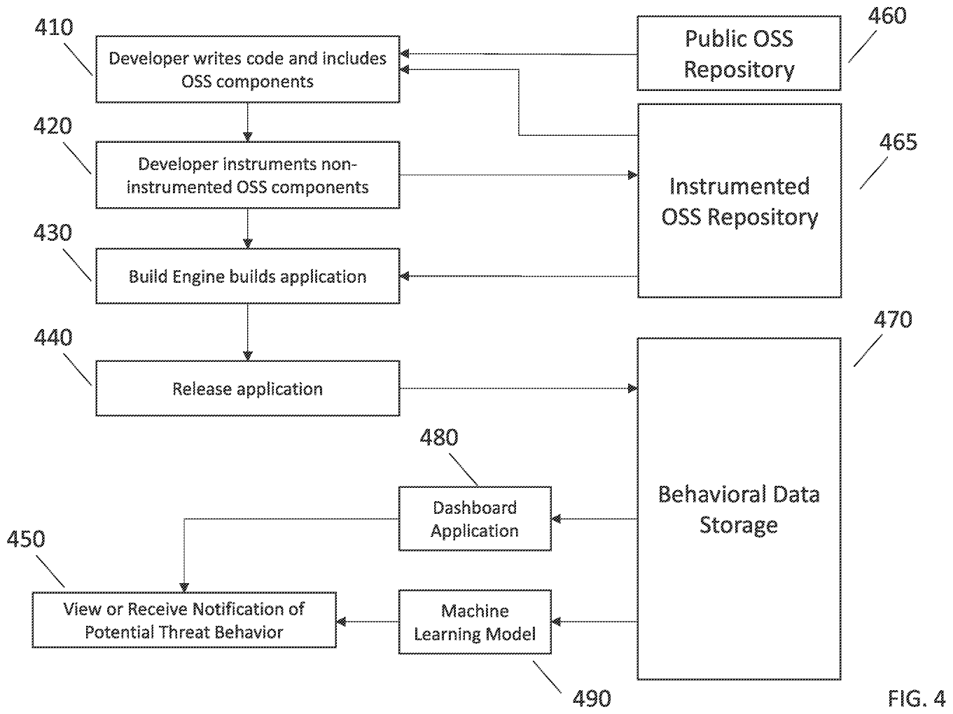

FIG. 4 is diagram of example operations and components. At operation 410, an application developer writes code that includes OSS components. The application developer may be one or more individuals and may be associated with any industry, academic, and/or government entity, among others. The OSS components may be components from a public OSS repository 460 and/or from a repository of instrumented OSS components 465. At block 420, the developer instruments any non-instrumented OSS components. As described above herein, an OSS component may be instrumented using tools such as Rollbar or Sentry, among others. By instrumenting an OSS component, execution of the OSS component will generate reports regarding aspects of the execution, such as, without limitation, which routines are being called, the memory settings, execution order, and exceptions being raised, among others. Any OSS component that the developer instruments may be communicated to and stored by the repository of instrumented OSS components 465. In embodiments, all OSS components used in the code should be instrumented.

At block 430, a build engine builds the application. In building the application, any information needed regarding instrument OSS components may be retrieved from the repository of instrumented OSS components 465. At block 440, the application is released. As described above in connection with FIG. 1, the released application may execute in any system, device, and/or server of the networked environment of FIG. 1, such as in one or more client computer systems 110, 120, one or more mobile devices 140, 160, and/or one or more IoT devices 170, 180, among other things.

When the application is executed, the instrumentation generates reports and data relating to the execution, such as, without limitation, which routines are being called, the memory settings, execution order, and exceptions being raised, among others. The reports and data are communicated to and stored in a behavioral data storage 470. In embodiments, the behavioral data storage 470 may include a cloud storage of the instrumentation tool provider, such as a cloud storage of Rollbar or Sentry. In embodiments, the behavioral data storage 470 may include a cloud storage not associated with the instrumentation tool provider.

Various applications may access and use the reports and data in the behavioral data storage 470. In embodiments, a dashboard application 480 may access the reports and data in the behavioral data storage 470 to provide a visualization of the reports and data. For example, the dashboard application 480 may identify the line(s) of code that are being exploited and identify the identity of the developer based on the git contribution to the OSS maintainer. For example, if pytorch (a public library) is exploited, the consumer of the pytorch library would be notified, and the maintainers of the pytorch library would be notified and given information such as, without limitation, the identity of the person who wrote the susceptible algorithm, the inputs from the stack trace (e.g., for debugging purposes), and descriptions of the unexpected behavior, so the library maintainers can take appropriate action. In embodiments, and as described above, a machine learning model 490 may access the behavioral data storage 470 for training and/or for processing the reports and data to determine whether OSS component behavior is normal behavior (e.g., 312, FIG. 3) or potential threat behavior (e.g., 314, FIG. 3). In embodiments, the reports and data from the behavioral data storage 470 may be collected using Splunk.

At operation 450, cyber security personnel or any other user may use the dashboard application 480 and/or the machine learning model 490 to view and/or receive notification of real-time alerts for unexpected or potential threat behavior. In embodiments, the dashboard application 480 may push notifications to a cyber security personnel or other user, such as a user of the company that released the application, to notify them of potential threat behavior in real-time or near-real-time. The notifications may be presented in various forms, including visual, haptic, and/or audio alerts. For example, the notification may be displayed on a graphical user interface (GUI) of a user device, such as a desktop, laptop, or mobile device 140, 160 and/or include an audible alarm. In another example, a visual indicator (e.g., icon or radio button) may change color based on the likelihood and/or severity of the potential threat behavior. In another example, a component of a user device (e.g., mobile device or mouse) may provide haptic feedback upon detection of a potential threat behavior. In embodiments, the notifications may be delivered to a device via an e-mail, text message, or other messaging system. If any OSS component is detected to have potential threat behavior, the machine learning model 490 and/or the cyber security personnel of operation 450 may serve as a threat intelligence source and describe how cyber-attackers (e.g., nation states and bad actors) are exploiting flaws in OSS components.

In embodiments, the reports and data in the behavioral data storage 470 may be used for “continual learning” and training for the machine learning model 490. In embodiments, when the machine learning model 490 has been trained with reports and data from the behavioral data storage 470, some or all of the reports and data that have been used in the training may be deleted from the behavioral data storage 470. In this manner, the large amount of data in the behavioral data storage 470 may be maintained and managed in a practical manner. At the same time, knowledge from the reports and data are preserved by way of the trained machine learning model 490.

The illustration of FIG. 4 is merely an example. Various operations and blocks not shown in FIG. 4 may be included. In embodiments, various operations and blocks shown in FIG. 4 may be omitted or may be in a different order than that illustrated. Such and other embodiments are contemplated to be within the scope of the present disclosure.

Threat intelligence is important for understanding cyber-attack tactics, methods, and capabilities. The disclosed solution takes advantage of advances in instrumentation technologies and couples it with data warehousing, anomaly detection techniques, and machine learning to infer relative targets and attacker intents and to identify potential remediation strategies.

Instrumenting OSS components and building a trusted repository that provides real-time insight into behavior is an evolutionary step towards real-time risk management. A build engine that incorporates only instrumented OSS components provides additional security. The runtime data collected with the instrumentation tool provides in-depth behavioral monitoring that can be used to identify unexpected behavior, thwart an attack in real-time, and provide the OSS community the information necessary to identify the lines of code that need to fixed, isolate bad actors with trends of contributing flawed code, notify users of public libraries of the vulnerability, and generate attack signatures for other defensive technologies such as Web Application Firewalls, Intrusion Detection Systems/Intrusion Prevention Systems, and Security Incident and Event Management Systems.

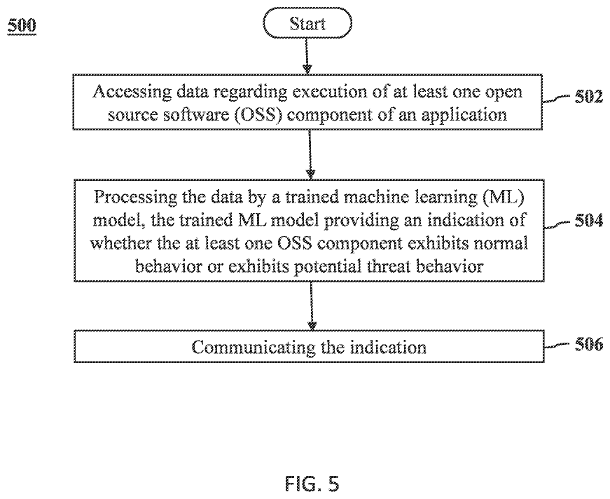

FIG. 5 shows a block diagram for an exemplary operation 500 for detecting threats relating to open source software components. Although the blocks of FIG. 5 are shown in a particular order, the blocks need not all be performed in the specified order, and certain blocks can be performed in any suitable order. For example, FIG. 5 will be described below with a system (e.g., 130, FIG. 1) performing portions of the operations. In various aspects, the operations of FIG. 5 may be performed, all or in part, by components of a system, e.g., as shown in FIG. 2. For example, the operations of FIG. 5 may be performed, in part, by another device, for example, a system 130 that includes the components of FIG. 2.

At block 502, the operation involves accessing data regarding execution of at least one open source software (OSS) component of an application. As discussed above, the application may be software or firmware and may be deployed on any platform, such as on the client computer systems 110, 120, on mobile devices 140, 160, and/or on IoT devices 170, 180. The at least one OSS component may be part of a repository of instrumented OSS components accessed by a developer and/or by build automation software for the client computer systems 110, 120. The data regarding execution of the at least one OSS component may be communicated to and stored in the system 130.

At block 504, the operation involves processing the data by a trained machine learning (ML) model. In embodiments, the ML model may be a deep neural network trained by supervised training. The trained ML model may be configured to process the data from the at least one OSS component to detect various behaviors. For example, the trained ML model may provide an indication of whether the at least one OSS component exhibits normal behavior or exhibits potential threat behavior. The potential threat behavior may include a cyber attack used to weaponize OSS components, such as a malicious, covert logic channel triggered by a flawed exception handler.

At block 506, the operation involves communicating the indication of whether the at least one OSS component exhibits normal behavior or exhibits potential threat behavior. If the at least one OSS component exhibits potential threat behavior, an alert notification may be presented. As discussed above, the alert may include a visual, haptic, and/or audio alert. For example, a GUI of dashboard application 480 may display a notification to a cyber security personnel in real-time. In another example, a user may receive a text message on a mobile device 140, 160. Such prompt notifications may alert security personnel to act quickly to prevent a potential cyber attacker from executing malicious code using the at least one OSS component.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

The systems, devices, and/or servers described herein may utilize one or more processors to receive various information and transform the received information to generate an output. The processors may include any type of computing device, computational circuit, or any type of controller or processing circuit capable of executing a series of instructions that are stored in a memory. The processor may include multiple processors and/or multicore central processing units (CPUs) and may include any type of device, such as a microprocessor, graphics processing unit (GPU), digital signal processor, microcontroller, programmable logic device (PLD), field programmable gate array (FPGA), or the like. The processor may also include a memory to store data and/or instructions that, when executed by the one or more processors, causes the one or more processors to perform one or more methods and/or algorithms.

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed:

1. A method comprising:
accessing data regarding execution of at least one open source software (OSS) component of an application;
processing the data by a trained machine learning (ML) model, the trained ML model providing an indication of whether the at least one OSS component exhibits normal behavior or exhibits potential threat behavior; and
communicating the indication.

2. The method of claim 1, wherein the at least one OSS component is instrumented by an instrumentation tool,
the method further comprising generating, by the instrumentation tool, the data regarding execution of the at least one OSS component.

3. The method of claim 1, wherein the data regarding execution of the at least one OSS component comprises at least one of: which routines are called, memory settings, execution order, or exceptions raised.

4. The method of claim 3, wherein processing the data by the trained ML model comprises inputting, to the trained ML, at least one of: which routines are called, memory settings, execution order, or exceptions raised.

5. The method of claim 1, wherein the trained ML model comprises a neural network trained by supervised learning.

6. The method of claim 1, further comprising performing continual learning for the trained ML model using new input training data.

7. A system comprising:
at least one processor; and
one or more memory storing instructions which, when executed by the at least one processor, cause the system at least to:
access data regarding execution of at least one open source software (OSS) component of an application;
process the data by a trained machine learning (ML) model, the trained ML model providing an indication of whether the at least one OSS component exhibits normal behavior or exhibits potential threat behavior; and
communicate the indication.

8. The system of claim 7, wherein the at least one OSS component is instrumented by an instrumentation tool,
wherein the instructions, when executed by the at least one processor, further cause the system at least to:
generate, by the instrumentation tool, the data regarding execution of the at least one OSS component.

9. The system of claim 7, wherein the data regarding execution of the at least one OSS component comprises at least one of: which routines are called, memory settings, execution order, or exceptions raised.

10. The system of claim 9, wherein processing the data by the trained ML model comprises inputting, to the trained ML, at least one of: which routines are called, memory settings, execution order, or exceptions raised.

11. The system of claim 7, wherein the trained ML model comprises a neural network trained by supervised learning.

12. The system of claim 7, wherein the instructions, when executed by the at least one processor, further cause the system at least to: perform continual learning for the trained ML model using new input training data.

13. A processor-readable medium storing instructions which, when executed by at least one processor of a system, causes the system at least to perform:
accessing data regarding execution of at least one open source software (OSS) component of an application;
processing the data by a trained machine learning (ML) model, the trained ML model providing an indication of whether the at least one OSS component exhibits normal behavior or exhibits potential threat behavior; and
communicating the indication.

14. The processor-readable medium of claim 13, wherein the at least one OSS component is instrumented by an instrumentation tool, and
wherein the instructions, when executed by the at least one processor of the system, further cause the system to perform:
generating, by the instrumentation tool, the data regarding execution of the at least one OSS component.

15. The processor-readable medium of claim 13, wherein the data regarding execution of the at least one OSS component comprises at least one of: which routines are called, memory settings, execution order, or exceptions raised.

16. The processor-readable medium of claim 15, wherein processing the data by the trained ML model comprises inputting, to the trained ML, at least one of: which routines are called, memory settings, execution order, or exceptions raised.

17. The processor-readable medium of claim 13, wherein the trained ML model comprises a neural network trained by supervised learning.

18. The processor-readable medium of claim 13, wherein the instructions, when executed by the at least one processor of the system, further cause the system to perform:
performing continual learning for the trained ML model using new input training data.
